(19) United States
(12) Patent Application Publication
(10) Pub. No.: US 2015/0060409 A1
(43) Pub. Date: Mar. 5, 2015

(54) Vacuum Switch

(71) Applicant: Hitachi, Ltd., Chiyoda-ku, Tokyo (JP)

(72) Inventors: Shinsuke Iitsuka, Tokyo (JP); Kenji Tsuchiya, Tokyo (JP); Ayumu Morita, Tokyo (JP); Hiroyuki Shirai, Tokyo (JP)

(21) Appl. No.: 14/379,722

(22) PCT Filed: Jan. 21, 2013
(86) PCT No.: PCT/JP2013/051025

§ 371 Date: Aug. 19, 2014

(30) Foreign Application Priority Data
Mar. 28, 2012 (JP) 2012-072992

(51) Int. Cl. H01H 33/66

(52) U.S. Cl. CPC H01H 33/6606
USPC 218/118

(57) ABSTRACT

An object is to obtain a vacuum switch that can achieve higher insulation properties to improve reliability. In a vacuum switch for interrupting a single-phase alternating current, three vacuum valves (VI) for a three-phase alternating current are coupled together in series. Specifically, the three vacuum valves for a three-phase alternating current are coupled together in such a manner that the current flows through adjacent vacuum valves in the same direction or in such a manner that the current flows through adjacent vacuum valves in different directions.

### TECHNICAL FIELD

The present invention relates to a vacuum switch and in particular to a vacuum switch which is suitably used as a single-phase alternating current interruption switch for use in an electric railway, or the like.

### BACKGROUND ART

Generally, a Shinkansen (super express train) vehicle of an electric railway, for example, a railway vehicle 20 as shown in FIG. 1 performs power running without reducing the traveling speed in a dead section by quickly switching between a current interruption vacuum switch VS1 and a current passage vacuum switch VS2 in an interlocking manner.

For example, assume that in FIG. 1, the railway vehicle 20 travels a dead section called an “ac-ac section,” which is disposed between sections having alternating current frequencies of 50 Hz and 60 Hz, respectively, on the same railway track and which is intended to prevent mixing of the different frequencies. The railway vehicle 20 is fed by a railway substation G1 and thus performs power running; when it enters the dead section, a vehicle detector works, thereby turning off the current interruption vacuum switch VS1 and turning on the current passage vacuum switch VS2; and then the railway vehicle 20 is fed by a railway substation G2 through a feeder line 21.

However, when the current interruption vacuum switch VS1 is on and the current passage vacuum switch VS2 is off as shown in FIG. 1, an alternating current feed voltage V₁ from the railway substation G1 and an alternating current feed voltage V₂ from the railway substation G2 are applied to the current passage vacuum switch VS2. At this time, as shown in FIG. 2, a maximum potential difference of |V_{1Max}|+|V₂ₘᵢₙ|, or |V₁ₘᵢₙ|+|V_{2Max}| occurs across the current passage vacuum switch VS2.

Note that when the current is passed, the electrode surfaces become rough due to advanced discharge, and conductive foreign matter arising from the surfaces tends to cause electrical breakdown between the electrodes. Accordingly, it is preferable to improve insulation reliability.

Since a potential difference as described above occurs, two vacuum valves VI (vacuum interrupters) are coupled together in series in a traditional vacuum switch VS, as shown in FIGS. 3 and 4. Thus, withstand voltage performance of the open electrodes of each vacuum valve VI is improved.

Specifically, assuming that the feed voltage of the railway substation G1 and the feed voltage of the railway substation G2 are V₁ [V] and V₂ [V], respectively, and that two vacuum valves VI are coupled together in series, a maximum potential difference V_{K} which occurs across each vacuum valve VI is reduced to V_{K}/2, as shown in FIG. 5.

Prior art documents related to a dead section include Patent Literature 1. Patent Literature 1 discloses that a switching section is disposed between two trolley lines having different power supplies on a Shinkansen; switch interrupters are coupled between a first trolley line and the switching section and between a second trolley line and the switching section, respectively; switching is performed between the two switching circuit breakers in accordance with the traveling of the vehicle, so that the power supply of the first trolley line or that of the second trolley line applies a voltage to the switching section; and thus the vehicle passes through the switching section while keeping the notch on.

### CITATION LIST

### Patent Literature

Patent Literature 1: Japanese Unexamined Patent Application Publication No. 2002-369311

### SUMMARY OF INVENTION

### Technical Problem

As described above, two vacuum valves VI are coupled together in series in the traditional vacuum switch and thus withstand voltage performance of the open electrodes of each vacuum valve is improved. Further, assuming that the feed voltage of the railway substation G1 and the feed voltage of the railway substation G2 are V₁ [V] and V₂ [V], respectively, a maximum potential difference V_{K} which occurs across each vacuum valve V1 is reduced to V_{K}/2, as shown in FIG. 5.

While vacuum switches have been required to have higher insulation characteristics in recent years, the traditional structure, where two vacuum valves are coupled together in series, has a limit to obtaining higher insulation properties. Patent Literature 1 has no description on improving of the insulation properties of the switch or description on the structure of the switching circuit breaker.

The present invention has been made in view of the foregoing, and an object thereof is to provide a vacuum switch that can achieve higher insulation properties to improve reliability.

### Solution to Problem

To achieve the above object, a vacuum switch according to the present invention is a vacuum switch for interrupting a single-phase alternating current and includes three vacuum valves (VI) for a three-phase alternating current which are coupled together in series.

Specifically, the three vacuum valves for a three-phase alternating current are coupled together in such a manner that a current flows through the adjacent vacuum valves in the same direction or in such a manner that a current flows through the adjacent vacuum valves in different directions.

Further, the three vacuum valves for a three-phase alternating current are coupled together in such a manner that the adjacent vacuum valves are coupled together through solid insulated busbars.

Further, the three vacuum valves for a three-phase alternating current are collectively molded.

### Advantageous Effects of Invention

According to the present invention, it is possible to obtain a vacuum switch that can achieve higher insulation properties to improve reliability.

### BRIEF DESCRIPTION OF DRAWINGS

FIG. 1 is a diagram showing a dead section on an electric railway.

FIG. 2 is a diagram showing a potential difference which occurs across a current passage vacuum switch VS2 in the dead section of FIG. 1.

FIG. 3 is a side view showing example coupling of vacuum valves VI in a traditional vacuum switch.

FIG. 4 is a front view of FIG. 3.

FIG. 5 is a diagram showing a maximum potential difference which occurs across each vacuum valve when vacuum valves VI are coupled together in a traditional vacuum switch.

FIG. 6 is a diagram showing first example coupling of vacuum valves VI in a vacuum switch according to the present invention.

FIG. 7 is a diagram showing second example coupling of vacuum valves VI in the vacuum switch according to the present invention.

FIG. 8 is a side view showing solid insulated busbars used to couple vacuum valves VI together in the vacuum switch according to the present invention.

FIG. 9 is a front view of FIG. 8.

FIG. 10 is a side view showing a state where a vacuum circuit breaker using the vacuum switch according to the present invention is stored in a cradle and where the vacuum switches are coupled together by solid insulated busbars.

FIG. 11 is a front view of FIG. 10.

FIG. 12 is a perspective view showing details of the vacuum circuit breaker included in the vacuum switch according to the present invention.

FIG. 13 is a diagram showing a state where a current is passing through the vacuum circuit breaker included in the vacuum switch of FIG. 12.

FIG. 14 is a diagram showing a state where a current is being interrupted by the vacuum circuit breaker included in the vacuum switch of FIG. 12.

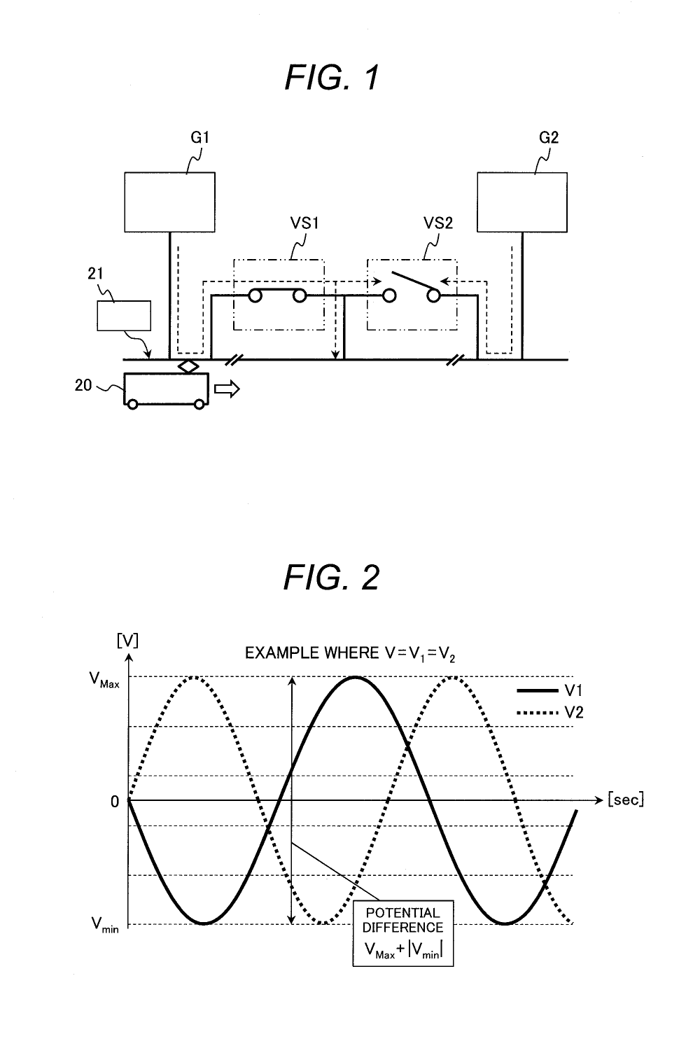

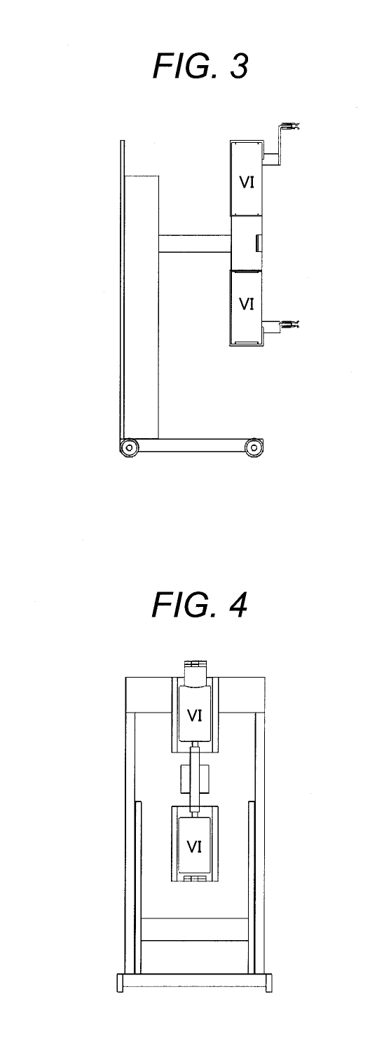

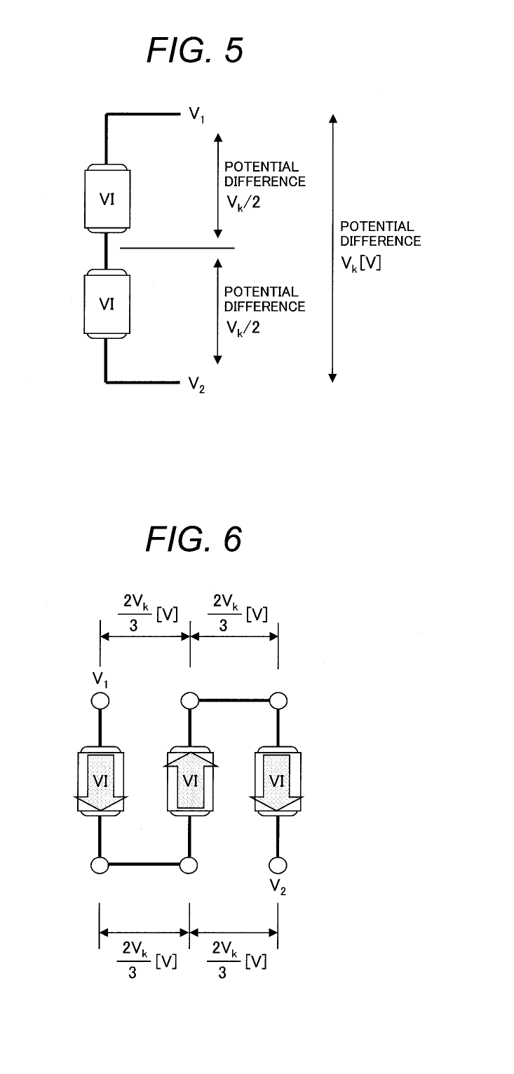

### DESCRIPTION OF EMBODIMENTS

Now, a vacuum switch according to an embodiment of the present invention will be described with reference to the drawings.

### First Embodiment

The present embodiment is intended to further improve the insulation reliability of a vacuum switch VS. Specifically, the present embodiment improves insulation performance by coupling three vacuum valves VI together in series rather than coupling two vacuum valves VI together in series as has been done traditionally.

In other words, the present embodiment is characterized in that three vacuum valves VI for a three-phase alternating current are coupled together in series in a vacuum switch for interrupting a single-phase alternating current.

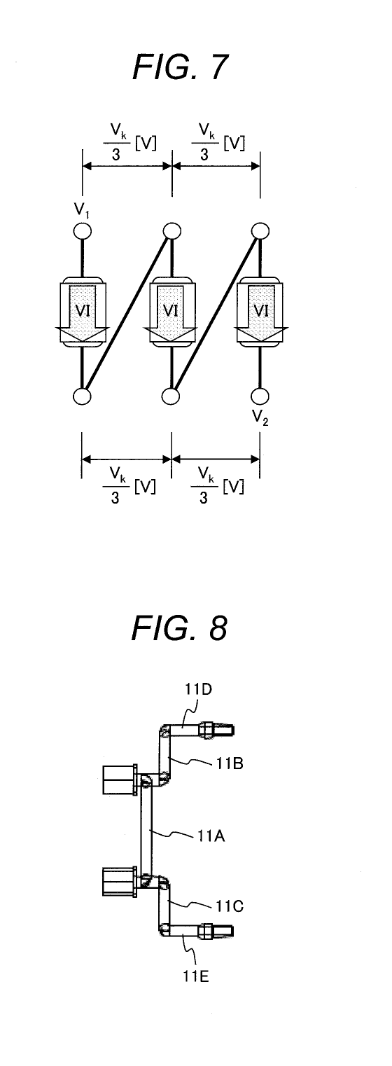

More specifically, three vacuum valves VI for a three-phase alternating current are coupled together in such a manner that the current flows through adjacent vacuum valves VI in the same direction, as shown in FIG. 6, or in such a manner that the current flows through adjacent vacuum valves VI in different directions, as shown in FIG. 7. In the example coupling configurations shown in FIGS. 6 and 7, a potential difference V_{K} [V] is considered, as in vacuum switches VS.

A device for different application for a vacuum circuit breaker VCB, instead of that for a vacuum switch VS, is used as an operation device for operating the vacuum valves VI. Note that while the feeder line is a feeder line for a single-phase alternating current, the vacuum circuit breaker is a vacuum circuit breaker for interrupting a three-phase alternating current.

Since the vacuum circuit breaker is intended to interrupt a three-phase alternating current, it includes three vacuum valves VI. That is, by coupling the three vacuum valves VI together in series, it is possible to interrupt the current at more points than those in a vacuum switch VS where two vacuum valves VI are coupled together in series.

In the coupling configuration shown in FIG. 6, where three vacuum valves VI are coupled together in series, a potential difference of 2V_{K}/3 [V] occurs between the terminals of the vacuum valves VI; in the coupling configuration shown in FIG. 7, where three vacuum valves VI are coupled together in series, a potential difference of V_{K}/3 [V] occurs between the terminals of the vacuum valves VI.

That is, use of the coupling configuration shown in FIG. 7, where three vacuum valves VI are coupled together in series, allows further reduction of the loads on the vacuum valves VI.

Further, consider the current flow direction. In the coupling configuration shown FIG. 6, where three vacuum valves VI are coupled together in series, the current flows through the center vacuum valve VI in the reverse direction (shown by [symbol] ). This may cause an electromagnetic repulsive force. On the other hand, in the coupling configuration shown in FIG. 7, where three vacuum valves VI are coupled together in series, the current flows in the same direction as that in the traditional coupling configuration.

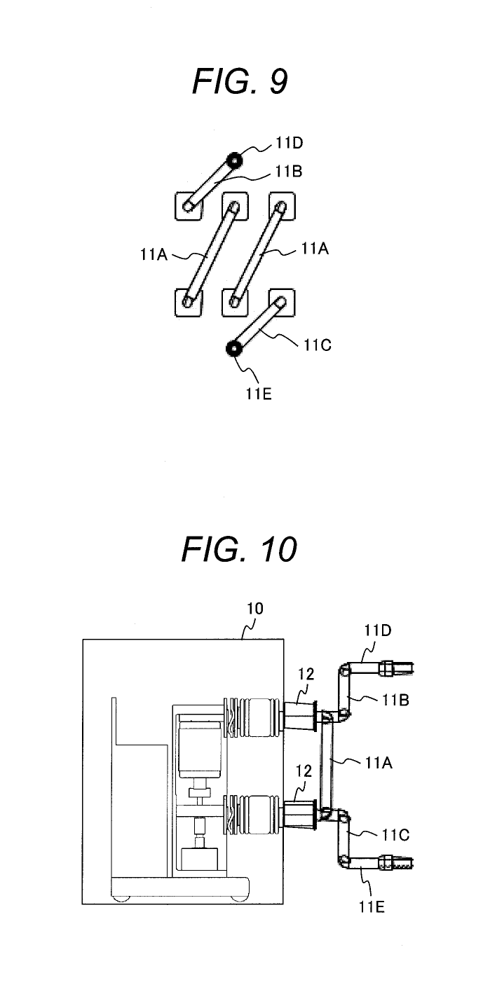

The coupling configuration shown in FIG. 7, where three vacuum valves VI are coupled together in series, is achieved by using solid insulated busbars 11A, 11B, 11C, 11D, and 11E shown in FIGS. 8 and 9. By coupling three vacuum valves VI together in series using these solid insulated busbars 11A, 11B, 11C, 11D, and 11E between the terminals of the vacuum circuit breaker as shown in FIG. 7, insulation is improved. Thus, it is possible to bring the conductors close each other like as the coupling configuration shown in FIG. 7. Further, since conductors such as copper busbars are not exposed but covered by an insulating material, it is possible to improve insulation properties, as well as antiseptic properties, rust prevention properties, and the like.

Typically, a vacuum circuit breaker is required to be used indoors and therefore it is not appropriate to install it outdoors as it is, unlike the vacuum switch VS. For this reason, the vacuum circuit breaker is stored in a cradle (metal box) including a holder for the terminals thereof so that it can be used outdoors.

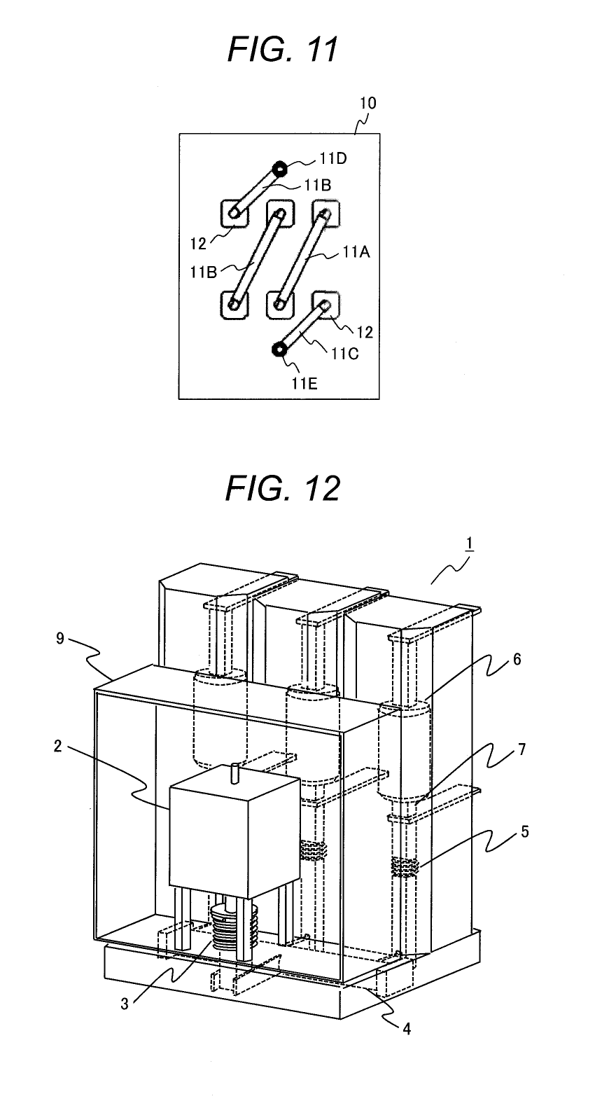

FIGS. 10 and 11 show a state where the vacuum circuit breaker is stored in a cradle and where the three vacuum valves VI are coupled together by the solid insulated busbars.

As shown in FIGS. 10 and 11, terminals 12 of the three vacuum valves VI of a vacuum circuit breaker 1 stored in a cradle 10 extend out of the cradle 10. The adjacent vacuum valves VI are coupled together by the solid insulated busbars 11A through the terminals 12, and the vacuum valves VI are coupled to the power supply side or load side through the solid insulated busbars 11B and 11D or solid insulated busbars 11C and 11E.

As seen above, by interrupting the current at three points using the vacuum circuit breaker where the three vacuum valves VI are coupled together in series, it is possible to further improve reliability, to reduce the potential difference of each the vacuum valve VI to V_{K}/3 [V], and to further improve the insulation properties between the vacuum valves VI.

Further, molding of vacuum valves VI (that is, mold insulation in place of air insulation) improves insulation properties, and collective molding of three vacuum valves VI allows downsizing.

For the insulation performance of vacuum valves VI used, just one vacuum valve is made capable of withstanding a potential difference of V_{KMax} [V], and reliability can be further improved by coupling together in series three vacuum valves VI.

The vacuum valves VI may be coupled together using the cradle 10 and the solid insulated busbars 11A, and a standard product having performance records may be used as the vacuum circuit breaker. By coupling vacuum valves VI included in the vacuum circuit breaker in series, the vacuum circuit breaker can have a function of interrupting a single-phase alternating current at three points.

Next, details of the vacuum circuit breaker including the vacuum switch of the present embodiment will be described with reference to FIGS. 12 to 14.

As shown in FIGS. 12 to 14, the vacuum circuit breaker 1 mainly includes an operation mechanism 2 configured to operate a movable rod 7 through a shaft 4; three vacuum valves each including electrodes 8 configured to interrupt and pass the current when the operation mechanism 2 operates the movable rod 7; and a case 9 coupling the three vacuum valves 6 together. By fixing the shaft 4 and operating the operation mechanism 2, the operation force is transmitted to the electrodes 8 of the vacuum valves 6 to interrupt or pass the current.

An interruption spring 3 and contact pressure springs 5 are disposed between the operation mechanism 2 and the vacuum valves 6. To pass the current, a contact pressure is applied to the electrodes 8 of each vacuum valve 6 by the force of the contact pressure spring 5; to interrupt the current, the electrodes 8 of each vacuum valve 6 are opened by the force of the contact pressure spring 5.

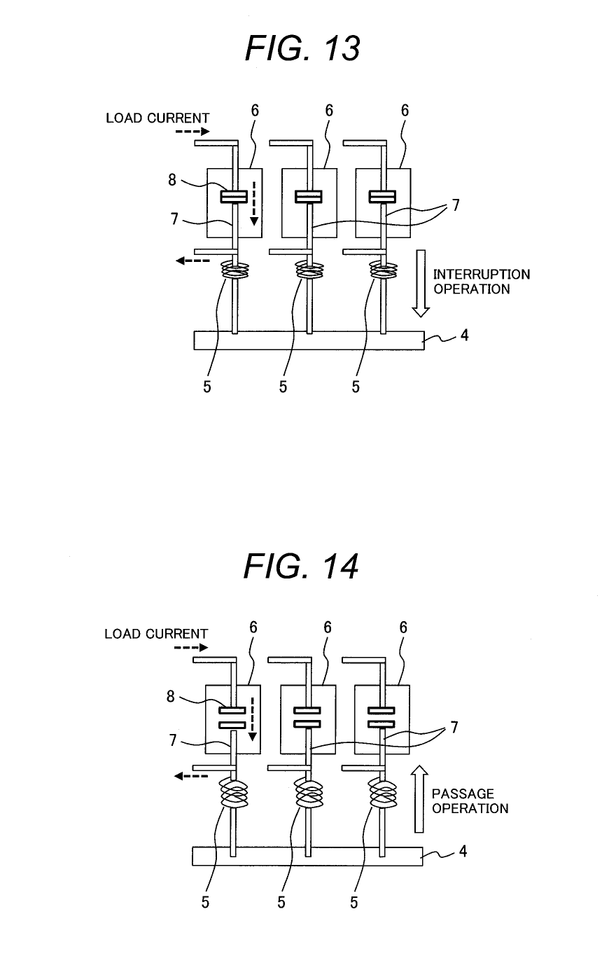

Specifically, when the operation mechanism 2 moves downward, each movable rod 7 moves upward, and the corresponding electrodes 8 contact each other. Thus, the current is passed (the state of FIG. 13). In contrast, when the operation mechanism 2 moves upward, each movable rod 7 moves downward, and the corresponding electrodes 8 are opened. Thus, the current is interrupted (the state of FIG. 14).

According to the present embodiment, the three vacuum valves VI are coupled together in series. Thus, it is possible to achieve much higher insulation properties to improve reliability. Also, by using the solid insulated busbars to couple the three vacuum valves VI together in series, it is possible to unify the current flow directions and to further improve the insulation performance between the vacuum valves VI. In this case, by electrically coupling the vacuum valves VI of different phases together in series using one vacuum circuit breaker which is usually used for a three-phase alternating current, the vacuum circuit breaker can serve as a circuit breaker for a single-phase alternating current. This increases the versatility of the vacuum circuit breaker for a three-phase alternating current.

Further, by molding the vacuum valves VI, insulation performance can be improved (compared to air insulation); by collectively molding the three vacuum valves VI to reduce the inter-phase insulation distance, the entire vacuum circuit breaker can be downsized; and by coupling the vacuum valves VI together in series using the solid insulated busbars, an electromagnetic operation device which is a standard product can be used.

Further, by coupling the three vacuum valves in series using the solid insulated busbars between the terminals of the vacuum circuit breaker for a three-phase alternating current, it is possible to interrupt a single-phase alternating current using the three vacuum valves.

### REFERENCE SIGNS LIST

1 . . . vacuum circuit breaker, 2 . . . operation mechanism, 3 . . . interruption spring, 4 . . . shaft, 5 . . . contact pressure spring, 6, VI . . . vacuum valve, 7 . . . movable rod, 8 . . . electrodes, 9 . . . case, 10 . . . cradle, 11A, 11B, 11C, 11D, 11E . . . solid insulated busbar, 12 . . . terminal, 20 . . . railway vehicle, 21 . . . feeder line, VS . . . vacuum switch, VS1 . . . current interruption vacuum switch, VS2 . . . current passage vacuum switch, G1, G2 . . . railway substation

1.-5. (canceled)

6. A vacuum switch for interrupting a single-phase alternating current, comprising:
three vacuum valves (VI) for a three-phase alternating current;
a vacuum circuit breaker including the three valves; and
a cradle configured to store the vacuum circuit breaker and including a holder for terminals of the vacuum circuit breaker,
wherein the adjacent vacuum valves are coupled together by solid insulated busbars through the terminals extending out of the cradle, and
wherein the three vacuum valves are coupled together in series.

7. The vacuum switch according to claim 6, wherein the three vacuum valves for a three-phase alternating current are coupled together in such a manner that a current flows through the adjacent vacuum valves in the same direction.

8. The vacuum switch according to claim 6, wherein the three vacuum valves for a three-phase alternating current are coupled together in such a manner that a current flows through the adjacent vacuum valves in different directions.

9. The vacuum switch according to claim 6, wherein the three vacuum valves for a three-phase alternating current are collectively molded.
